(19) United States
(12) Patent Application Publication
(10) Pub. No.: US 2023/0214876 A1
(43) Pub. Date: Jul. 6, 2023

(54) SYSTEM AND METHOD FOR REAL-TIME USER RESPONSE PREDICTION FOR CONTENT PRESENTATIONS ON CLIENT DEVICES

(71) Applicant: Skillz Platform Inc., San Francisco, CA (US)

(72) Inventors: Igor Raush, Boulder, CO (US); Levon Budagyan, Palo Alto, CA (US)

(21) Appl. No.: 18/089,979

(22) Filed: Dec. 28, 2022

Related U.S. Application Data
(60) Provisional application No. 63/266,186, filed on Dec. 30, 2021.

(51) Int. Cl. G06Q 30/0242; G06Q 30/0202; G06Q 30/0241

(52) U.S. Cl. CPC G06Q 30/0243; G06Q 30/0202; G06Q 30/0277

(57) ABSTRACT

In an aspect, a request to display information on a client device of a user can be received. A plurality of features associated with the request can be extracted. The plurality of features can include at least one feature characterizing the user and at least an additional feature characterizing the client device. A feature vector based on the features associated with the request can be generated. A predicted response value of the user to a content presentation can be generated using a predictive model and the feature vector. The predicted response value can characterize a likelihood of the user interacting with the content presentation. A request response value can be determined based on a content presentation impression value and the feature vector. The request response value and the content presentation can be transmitted for display on the client device of the user.

### CROSS-REFERENCE TO RELATED APPLICATIONS

This application claims the benefit of U.S. Provisional Application No. 63/266,186, filed Dec. 30, 2021, the entire contents of which are hereby incorporated by reference herein.

### BACKGROUND

Client devices can present a wide variety of digital content to users, including video, audio, images, and combinations thereof. Content is often developed and used to achieve a certain response from a user exposed to the content. Some content can encourage a user to take a certain action, such as interacting or engaging with a client application, purchasing a product or service, or installing a client application. However, not all users will respond to the digital content presented to them, so presenting all users with the same digital content may result in wasted resources and be unproductive. Determining whether and which users will respond to the digital content can be difficult, time consuming, and expensive.

### SUMMARY

Systems and methods for real-time user response prediction for content presentations on client devices are provided. Related apparatus, techniques, and articles are also described.

In an aspect, a request to display information on a client device of a user can be received. A plurality of features associated with the request can be extracted. The plurality of features can include at least one feature characterizing the user and at least an additional feature characterizing the client device. A feature vector based on the plurality of features associated with the request can be generated. A predicted response value of the user to a content presentation can be generated using a predictive model and the feature vector. The predicted response value can characterize a likelihood of the user interacting with the content presentation. A content presentation impression value can be generated, when the predicted response value satisfies a predetermined threshold, using the predicted response value and a target value associated with the user. The target value can characterize a cost of an interaction of the user with the content presentation. A request response value can be determined based on the content presentation impression value and the feature vector. The request response value and the content presentation can be transmitted for display on the client device of the user.

One or more features can be included in any feasible combination. For example, the predictive model can be a Bayesian Logistic Regression model. For example, the predicted response value can further characterize a likelihood of a downstream conversion of the user in response to interacting with the content presentation. For example, the content presentation impression value can be generated using the predicted response value and the target value associated with the user by multiplying the target value and the predicted response value. For example, the content presentation for display on the client device of the user can be selected based on the feature vector. For example, an alternative content presentation for display on the client device can be selected responsive to determining that the predicted response value of the user to the content presentation does not satisfy the predetermined threshold. For example, an additional predicted response value of the user to the alternative content presentation can be generated using the predictive model and the feature vector. For example, an additional content presentation value can be generated, when the additional predicted response value satisfies the predetermined threshold, using the additional predicted response value and the target value associated with the user. In other examples, a filter model in association with the predictive model can be implemented. For example, the implementing of the filter model can include determining an additional likelihood that the user interacts with a particular category associated with one or more additional content presentations.

In another aspect, a system is provided and can include at least one data processor and memory storing instructions configured to cause the at least one data processor to perform operations described herein. The operations can include receiving a request to display information on a client device of a user; extracting a plurality of features associated with the request, the plurality of features including at least one feature characterizing the user and at least an additional feature characterizing the client device; generating a feature vector based on the plurality of features associated with the request; generating a predicted response value of the user to a content presentation using a predictive model and the feature vector, the predicted response value characterizing a likelihood of the user interacting with the content presentation; generating, when the predicted response value satisfies a predetermined threshold, a content presentation impression value using the predicted response value and a target value associated with the user, the target value characterizing a cost of an interaction of the user with the content presentation; determining a request response value based on the content presentation impression value and the feature vector; and transmitting the request response value and the content presentation for display on the client device of the user.

One or more features can be included in any feasible combination. For example, the predictive model can be a Bayesian Logistic Regression model. For example, the predicted response value further characterizes a likelihood of a downstream conversion of the user in response to interacting with the content presentation. For example, the at least one data processor can perform the operation of the generating the content presentation impression value using the predicted response value and the target value associated with the user by multiplying the target value and the predicted response value. For example, the operations can further comprise selecting the content presentation for display on the client device of the user based on the feature vector. For example, the operations can further comprise selecting an alternative content presentation for display on the client device responsive to determining that the predicted response value of the user to the content presentation does not satisfy the predetermined threshold. For example, the operations can further comprise generating an additional predicted response value of the user to the alternative content presentation using the predictive model and the feature vector. For example, the operations can further comprise implementing a filter model in association with the predictive model. For example, the operation of implementing the filter model can include determining an additional likelihood that the user converts in a particular category associated with one or more additional content presentations.

In yet another aspect, non-transitory computer program products (i.e., physically embodied computer program products) are also described that store instructions, which, when executed by at least one data processor forming part of at least one computing systems, cause the at least one data processor to perform operations herein. The operations comprise receiving a request to display information on a client device of a user; extracting a plurality of features associated with the request, the plurality of features including at least one feature characterizing the user and at least an additional feature characterizing the client device; generating a feature vector based on the plurality of features associated with the request; generating a predicted response value of the user to a content presentation using a predictive model and the feature vector, the predicted response value characterizing a likelihood of the user interacting with the content presentation; generating, when the predicted response value satisfies a predetermined threshold, a content presentation impression value using the predicted response value and a target value associated with the user, the target value characterizing a cost of an interaction of the user with the content presentation; determining a request response value based on the content presentation impression value and the feature vector; and transmitting the request response value and the content presentation for display on the client device of the user.

Computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

### BRIEF DESCRIPTION OF THE DRAWINGS

The embodiments described above will be more fully understood from the following detailed description taken in conjunction with the accompanying drawings. The drawings are not intended to be drawn to scale. For purposes of clarity, not every component may be labeled in every drawing. In the drawings:

FIG. 1 is a block diagram illustrating an example system for real-time user response prediction;

FIG. 2 is a block diagram illustrating an example method for real-time user response prediction;

FIG. 3 is a block diagram illustrating another example method for prediction of a user response to content presentations displayed on a client device; and

FIG. 4 is a block diagram of an example computing device that may perform one or more of the operations described herein, in accordance with the present embodiments.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The present invention is directed to a system and method for real-time user response prediction for content presentations on client devices. According to the present invention, an automated process can predict the likelihood that a user will engage with content presentations or other digital content presented on their client device. Embodiments of the present invention can use a suitable machine learning model to predict such user responses in real-time. The predictions can be used to calculate an impression value of the content presentation that can be used, for example, to generate, determine, or optimize responses to requests to display or otherwise present the content presentations on the client devices of the users. Merely for purposes of discussion and not limitation, the present disclosure will refer to content presentations on mobile devices to illustrate various aspects of the present invention. However, the present invention can be used in and with any suitable type of system for which the predicted responses of users can be used to determine and select the type, format, and content of information to present to the users in real-time on their client devices.

Embodiments of the present invention can improve computer processing efficiency by determining and selecting the type, format, and content of information to present to users on client devices based on the predicted responses of those users rather than through time- and processor-intensive trial-and-error and other like computer-based methodologies, particularly when there are large numbers of users and content presentations (e.g., millions, tens of millions, etc.) that must be processed in minute fractions of a second. Additionally, embodiments of the present invention can use a linear model (e.g., a logistic regression model or the like) to make predictions within such strict time constraints and to process millions of requests per second without the use of specialized computer hardware to make such predictions. Such linear models can also allow for the quick ingestion of new data to make the most accurate predictions. Furthermore, embodiments of the present invention can use a Bayesian approach to quantify uncertainty in the predictions and to efficiently balance content presentation inventory exploration and exploitation that are not achievable through trial-and-error and other like computer-based methodologies.

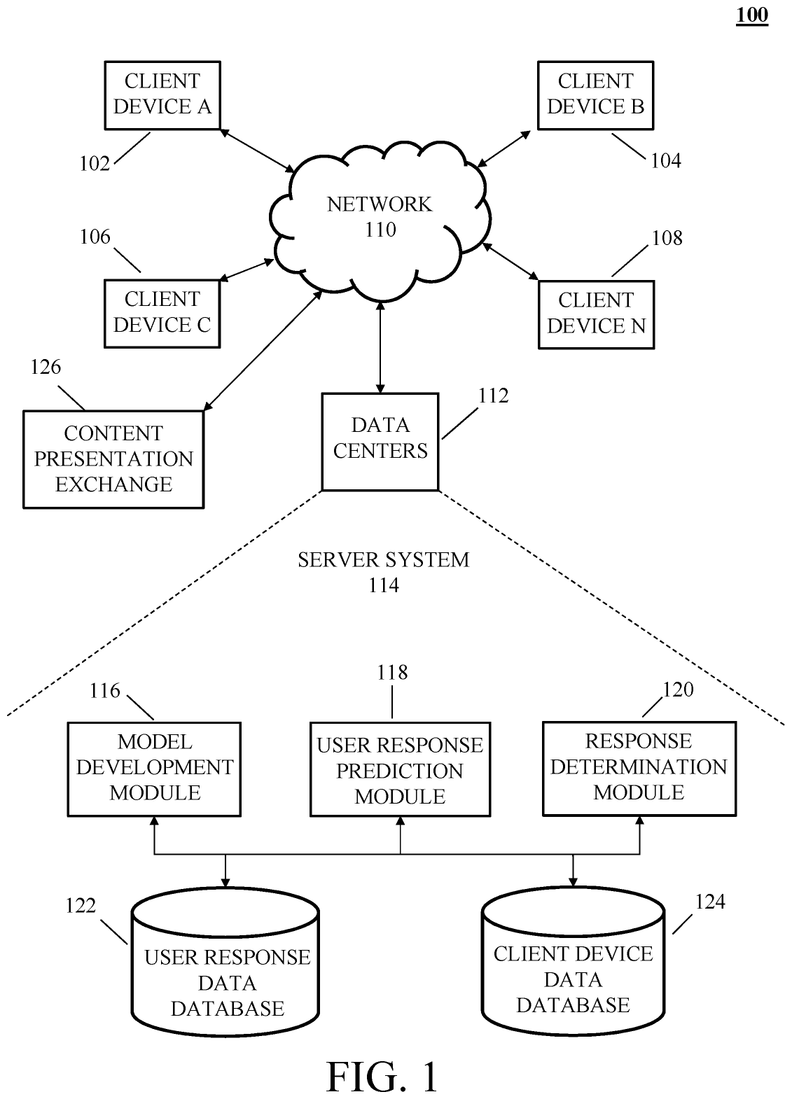

FIG. 1 is a block diagram illustrating an example system 100 for real-time user response prediction for content presentations on client devices. A server system 114 can provide functionality for developing a predictive model, using the predictive model to predict user responses to content presentations in real-time, and generating, determining, or otherwise optimizing responses to requests to present the content presentations on client devices of users. In embodiments, a content presentation can be any suitable type of digital content that is capable of being served, presented, or otherwise displayed to users on client devices, such as, for example, digital advertisements, creative assets, or other presentations of digital content or the like, and can include text, images, video, audio, or any combination thereof. The content presentation can be used for any appropriate purpose to achieve a desired response from users who are exposed to the content presentation. The server system 114 can include software components and databases that can be deployed at one or more data centers 112 in, for example, one or more geographic locations. The software components of the server system 114 can include a model development module 116, a user response prediction module 118, and a response determination module 120. The software components can include subcomponents that can execute on the same or on different individual data processing apparatus. The databases of the server system 114 can include, for example, a user response data database 122 and a client device data database 124. The databases can reside in one or more physical storage systems or be cloud-based. The software components and data will be further described below.

As illustrated in FIG. 1, the model development module 116, the user response prediction module 118, and the response determination module 120 can communicate with the user response data database 122 and the client device data database 124. The user response data database 122 can include data associated with users, user responses to content presentations, user information (e.g., age, gender, device identifier, etc.), content presentation response or bid history (e.g., publisher, category, bids, impressions, sampled auctions, etc.), user response history (e.g., clicks, installs, in-app purchases, in-app revenue, number of purchases, content presentation interactions (e.g., view completions), etc.), content presentation performance metrics (e.g., click through rate, cost per action, etc.), install and post-install events (e.g., in-app purchases, content presentation revenue, etc.), publisher information (e.g., application, category, etc.), content presentation context (e.g., Wi-Fi/cellular to reflect the context in which the content presentation was displayed), content presentations and/or information related to content presentations, such as, for example, images, videos, sounds, text, and the like, and can include descriptions of characteristics or features present in the content presentations (e.g., format of the content presentations), content presentation placement information, time/date (e.g., time of day, day of week, week of year, etc.), user geographical information (e.g., country, region, designated marketing areas (DMAs), etc.), and the like. Other user response data is possible. The client device data database 124 can include information or characteristics related to the client devices of users, such as, for example, client device model, carrier, client device operating system, in-app events, client device characteristics (e.g., price, hardware, storage, etc.), summarized statistics calculated from such data and/or data from the user response data database 122, and the like. Other client device information or characteristics is possible.

A software application or components thereof can execute on client devices of users, such as client device A 102, client device B 104, client device C 106, . . . , client device N 108 (where N can be any suitable natural number), and can access and be accessed through a network 110 (e.g., the Internet). Each of the client devices can be any appropriate type of electronic device that is capable of executing the software application and communicating with the server system 114 through the network 110, such as, for example, a smart phone, a tablet computer, a laptop computer, a desktop or personal computer, a gaming console, a set-top box, a smart television, or the like. Other client devices are possible. In an alternative embodiment, the user response data database 122, the client device data database 124, or any portions thereof can be stored on one or more client devices. Additionally or alternatively, software components for the system 100 (e.g., the model development module 116, the user response prediction module 118, and/or the response determination module 120) or any portions thereof can reside on or be used to perform operations on one or more client devices.

The software application, such as, for example, a web-based or mobile application (e.g., a publisher app), can be provided (e.g., by a publisher) as an end-user application to allow users to interact with the server system 114. Additionally, suitable digital content (e.g., content presentations) can be displayed to the user through or in association with the software application executing on the client device of the user. The software application can relate to and/or provide a wide variety of functions and information, including, for example, entertainment (e.g., a game, music, videos, etc.), business (e.g., word processing, accounting, spreadsheets, etc.), news, weather, finance, sports, etc. In certain embodiments, the software application can provide a mobile game. The mobile game can be or include, for example, a sports game, an adventure game, a virtual playing card game, a virtual board game, a puzzle game, a racing game, or any other appropriate type of mobile game. In an embodiment, the mobile game can be an asynchronous competitive skill-based game, in which players can compete against each other in the mobile game, but do not have to play the mobile game at the same time. In an alternative embodiment, the mobile game can be a synchronous competitive skill-based game, in which players can play the mobile game at the same time and can compete against each other in the mobile game in real-time. In an embodiment, the content presentations can be presented on the client devices outside of the software application and allow users to interact or engage with the content presentations, for example, by clicking or selecting on or within the content presentations. Additionally or alternatively, the software application can be configured to present content presentations within the software application on the client devices and allow users to interact or engage with the content presentations.

According to exemplary embodiments, the model development module 116 can be used to develop a user response prediction model to predict user responses to content presentations in real-time. In embodiments, any suitable predictive machine learning model can be appropriately trained and used to predict user responses in real-time. In some implementations of the present invention, a Bayesian Logistic Regression model can be used by the model development module 116 as the user response prediction model. Bayesian Logistic Regression is a probabilistic model that can automatically compute the probability of success for new data points. In some implementation of the present invention, the model development module 116 can build a model for a single entity (e.g., an advertiser or the like) or a group of entities (e.g., a group of advertisers or the like) that desire to display one or more content presentations on the client devices of users. The model development module 116 can arrange a predetermined number of categorical features (e.g., 5, 10, 15, or any suitable number) into a feature vector. The categorical features in a feature vector can be categorized or stored in the feature vector in any desired order. A feature vector can comprise a numerical representation of a combination of categorical features, such as user attributes and/or other attributes. For example, a feature vector can include a plurality of numbers (e.g., integers), with each number representing a different categorical feature. The feature vector can be of any appropriate length depending on the desired number of categorical features captured in the feature vector. In some implementations of the present invention, one-hot encoding can be used for all or part of the feature vector to calculate, convert, or otherwise map the numerical representations for each or any categorical features in a set of categorical features, although other suitable encoding techniques can be used. For purposes of illustration and not limitation, a feature vector having a length or magnitude M (where M is any suitable natural number) can include a numerical representation for the categorical feature of a particular publisher app as the m^{th} element of the feature vector. For one-hot encoding the publisher app A, if the m^{th} element of the feature vector is “1,” this can represent that the publisher app is A, otherwise the m^{th} element is “0” (i.e., the publisher app is not A). Other numerical representations of categorical features are possible. For example, the numerical representations can depend on the types and characteristics of the various user attributes and/or other attributes comprising the categorical features in the feature vector and how such categorical features are converted or mapped to numbers (e.g., integers) by one-hot encoding or other suitable encoding technique. For purposes of illustration and not limitation, the categorical features can include, for example, publisher app, country, time of day, day of week, Wi-Fi/cellular, region, DMA, carrier, device OS, ad format, in-app events, auction stream history (e.g., publisher and category), and the like. Other categorical features are possible and will depend on the use case. All or any of these categorical features can be encoded (e.g., one-hot encoded) and converted into corresponding numerical representations (e.g., integers) in the feature vector. In some implementations of the present invention, the users can be split into a plurality of groups or cohorts to maximize information gain. For example, users with one or more similar characteristics can be grouped into a first cohort, while users with other similar characteristics can be grouped into second, third, fourth, etc. cohorts. Any suitable number of cohorts can be used, and each or any of the cohorts can be specified with desired constraints based on, for example, the use case requirements.

In some implementations of the present invention, the model development module 116 can use a Bayesian Logistic Regression to determine the distribution of weight coefficients w given the data of a feature vector x as shown in Equation (1):

p(w|x,y)∝p(y|w,x)p(w) (1)

The prediction can be given by Equation (2):

p(y=1|w,x)=σ(w·x) (2)

where w is drawn from the distribution in Equation (1) (e.g., using Thompson sampling or the like). More particularly, the posterior on the weight coefficients can be expressed as in Equation (3):

$$p ( w \vert x , y ) ∝ p ( y \vert w , x ) p ( w ) = {\prod }_{i} [ B e r n ( {y}_{i} \vert {π}_{i )} ) ] {𝒩}_{d} ( w \vert {m}_{0} , {q}_{0}^{- 1} ) \qquad ( 3 )$$

where πᵢ=σ(xᵢ·w) and “Bern” represents the Bernoulli likelihood function. In Equation (3), m₀ and q₀ can reflect the prior knowledge on the mean and precision of each weight, respectively. The model development module 116 can determine the most likely value of w given the data, which can be referred to as the Maximum a Posteriori (MAP) estimate, according to Equation (4):

$$\begin{matrix}m = {arg max}_{w} p ( w \vert y ) \\ = \begin{matrix}{arg min}_{w} {\sum }_{i} [ {y}_{i} ln {π}_{i} + ( 1 - {y}_{i} ) ln ( 1 - {π}_{i} ) ] + \frac{1}{2} {( w - {m}_{0} )}^{T} \\ diag {( {q}_{0} )}^{- 1} ( w - {m}_{0} )\end{matrix}\end{matrix} \qquad ( 4 )$$

The model development module 116 can then apply a Laplace approximation to estimate the posterior precision of each weight according to Equation (5):

$$\begin{matrix}diag ( q ) = {∇}^{2} ln p ( w \vert y ) \\ = diag ( {q}_{0} ) + {\sum }_{i} {π}_{i} ( 1 - {π}_{i} ) {x}_{i} {x}_{i}^{T}\end{matrix} \qquad ( 5 )$$

In some implementations of the present invention, the predictive model built by the model development module 116 can be trained (e.g., using a suitable optimizer, such as, for example, mini-batch Limited-memory Broyden-Fletcher-Goldfarb-Shanno (L-BFGS) or the like) on suitable data and then periodically updated with incremental data as it is received by the server system 114. In an embodiment, app embeddings can be used to vectorize apps based on co-occurrence on client devices to extend predictions to similar apps (software applications) on similar client devices.

Other suitable predictive models can be used. For example, the predictive model can be or include, for example, one or more equations (e.g., regression equations or the like) and/or classifiers. In some embodiments, the predictive model can be or include Ridge, Lasso, Elastic Net, Adaptive Lasso, Group Lasso, Randomized Lasso, and/or other appropriate regression models. Additionally or alternatively, the predictive model can be or include a classifier such as, for example, one or more linear classifiers (e.g., Fisher's linear discriminant, logistic regression, Naive Bayes classifier, and/or perceptron), support vector machines (e.g., least squares support vector machines), quadratic classifiers, kernel estimation models (e.g., k-nearest neighbor), boosting (meta-algorithm) models, decision trees (e.g., random forests, Gradient Boosting Trees), neural networks, and/or learning vector quantization models, etc.

In some implementations of the present invention, the model development module 116 can use additional models to supplement or augment the base predictive model (e.g., the Bayesian Logistic Regression model) as ensemble models. In an embodiment, predictions from one or more additional models can be suitably combined (e.g., via multiplying, averaging, median, etc.) with each other and/or with the prediction generated by the base predictive model to improve or otherwise refine the prediction generated by the base predictive model. Additionally or alternatively, predictions from one or more additional models can be used as a filter to determine whether or not to submit a response (e.g., based on whether the predictions from the one or more additional models are above or below one or more predetermined or tunable thresholds). The model development module 116 can use suitable filter models to filter traffic in certain scenarios (e.g., for audience expansion, lookalike targeting, etc.). In an embodiment, the filter models can be based on a Pointwise Mutual Information (PMI) score, where the PMI score can be a measure of correlation between two events or the association between a feature and a class (e.g., a larger and/or different group of features). The PMI score can represent a quantified measure of how much more or less likely two events co-occur. For example, the PMI score can be representative of a correlation between one or more of the plurality of features and conversions in a particular category of, for instance, advertiser. The PMI score can compare the probability of two events occurring together to what this probability would be if the two events were independent. For example, a PMI score of 0 for two events x and y can represent that the particular events x and y are statistically independent. A positive PMI score can represent that the events x and y co-occur more frequently than would be expected if they were independent events. A negative PMI score can represent that the events x and y co-occur less frequently than would be expected. In some implementations of the present invention, the PMI score for a pair of events x and y can be calculated according to Equation (6):

$$PMI ( x , y ) = {log}_{2} [ \frac{p ( x , y )}{p ( x ) p ( y )} ] \qquad ( 6 )$$

Equation (6) can be based on maximum likelihood estimates, where p(x,y) can be the joint probability of random variables x and y divided by the product of the individual probabilities p(x) and p(y). For example, the following information can be determined according to some implementations of the present invention: (i) oₓ, which can be the number of observations of event x, (ii) o_{y}, which can be the number of observations of event y, and (iii) N, which can be the total size of the pool of observations. Given such information, the probabilities for the events x and y and for the co-occurrence of x and y can be determined using Equation (6) as follows: p(x)=oₓ/N and p(y)=o_{y}/N, and where p(x,y) can be number of observed co-occurrences of x and y. For purposes of illustration and not limitation, the PMI score can be measured between the presence of a software application (e.g., a publisher app) on the client device of a user and the fact that the user converted in a certain advertiser. Events between which a correlation can be determined can include, for example, how much does the fact that a user has app A on their client device increase the likelihood that the user makes a purchase in app B. The co-occurrence of other events as measured by a PMI score is possible. Additionally or alternatively, the filter models can be based on appropriate positive-unlabeled classifiers. For example, a suitable model can be trained to distinguish between a list of high-quality users and an “average” user. Although the predictions may be meaningless on their own, such results can be used to rank users by quality.

In some implementations of the present invention, a bid for an auction or auction-like process can be made using an install base prediction model (e.g., a Bayesian Logistic Regression model that can predict the likelihood of a user installing a product identified in a content presentation) if the filter probability satisfies (e.g., is greater than or less than) a predetermined or tunable threshold. In an embodiment, the threshold can be a tunable hyper-parameter, the value of which can be used to control the tradeoff between scale and performance for a given advertising campaign or the like. For instance, the model development module 116 can use the filter model to predict category-level purchaser likelihood. The category-level purchaser likelihood can measure the likelihood that a user will convert to a purchaser in a given category of advertiser or the like. If the category-level purchaser likelihood prediction satisfies (e.g., is greater than) a predetermined or tunable threshold (e.g., a tunable hyper-parameter, as discussed above), the model development module 116 can use the install base predictive model to make a suitable user response prediction. Otherwise, no user response prediction would be made using the install base predictive model. Other filter models are possible.

In an alternative embodiment, the model development module 116 can use suitable hierarchical models for an ensemble model as the base predictive model to, for example, pool data from related third-parties (e.g., advertisers or the like) while capturing third-party level effects (e.g., advertiser-level effects or the like). For example, the model development module 116 can train multi-level Bayesian Logistic Regression (BLR) hierarchical models using top-level coefficients as priors for lower levels of such a model. In some implementations of the present invention, a multi-level BLR hierarchical model can be a two-layer model with category-level prior and app-level model. Other hierarchical models are possible. Additionally or alternatively, the model development module 116 can use suitable multiplicative models for an ensemble model with the base predictive model. For example, the multiplicative model can decompose data according to Equation (7):

p(E|impression)=p(E|E1)p(E1|impression) (7)

where E1 can be a “pivot” event. The model development module 116 can train the p(E|E1) model on appropriate unattributed data and the p(E1|impression) model on appropriate attributed data. For example, the p(install|impression) model can be trained on suitable attributed data, while the p(purchaser|install) model can be trained on suitable unattributed data. Other multiplicative models are possible. For example, attributed data can be installs and post-install events that have been attributed to a particular entity's content presentation impressions. Unattributed or non-attributed data can be installs and post-install events that are not attributed to the entity (e.g., either they are attributed to another user acquisition channel or they are organic installs). For example, for unattributed or non-attributed data, there may not be information on the acquisition context, so the corresponding models can be built based on, for instance, the user profile.

In some implementations of the present invention, the model development module 116 can predict a response of a user to a content presentation (e.g., click, install, in-app purchase, etc.) using the predictive model (e.g., a Bayesian Logistic Regression model) to generate an expected value p, which can be a probabilistic value between 0 and 1. In other words, the predicted response can characterize a likelihood of the user interacting with the content presentation. In some implementations of the present invention, the predicted response value can additionally or alternatively characterize the likelihood of a downstream conversion of the user (i.e., the likelihood of the user taking some desired action in response to interacting with the content presentation). For example, the expected value p can represent the probability that the user converts after being exposed to the content presentation. Additionally or alternatively, the predictive model can also be used to predict continuous values in some use cases, such as, for example, expected purchase frequency, expected in-app revenue, and the like. In embodiments, the user response prediction module 118 can use the expected value p from the model development module 116 to calculate an impression value of the content presentation. In some implementations of the present invention, the user response prediction module 118 can calculate the impression value of the content presentation if the user response prediction p for the content presentation satisfies a suitable predetermined or tunable threshold (e.g., at or above 50%, 60%, 70%, etc.). In an embodiment, the content presentation impression value can be a value, in currency (e.g., dollars), of showing or otherwise displaying a content presentation impression to a user. In other words, the content presentation impression value can specify how much (in monetary value) is willing to be paid to show the content presentation to the user. If the user response prediction p does not satisfy (e.g., is below) the predetermined or tunable threshold, the user response prediction module 118 can select another (alternate) content presentation for which the user response prediction p satisfies (e.g., is at or above) the predetermined or tunable threshold. In some implementations of the present invention, an alternate content presentation may not be selected (and no response provided) if the user response prediction p does not satisfy the predetermined or tunable threshold.

The user response prediction module 118 can receive a request (e.g., a bid request or the like as part of an auction process or the like) from a content presentation exchange 126 (e.g., an ad exchange or the like) associated with a client device of a user (e.g., via network 110). The user response prediction module 118 can extract a context (i.e., a plurality of categorical features) from or otherwise associated with the request to generate a feature vector x of predetermined size (e.g., containing 5, 10, 15 or other suitable number of categorical features). The information can be obtained from the request itself in addition to or alternatively to information that can be retrieved or otherwise derived from either or both of the user response data database 122 and/or the client device data database 124. For purposes of illustration and not limitation, the feature vector x can include categorical features such as, for example, publisher (e.g., app, category, etc.), placement, user (e.g., age, gender, device identifier, etc.), time of day, day of week, week of year, geographical location (e.g., country, region, DMA, etc.), and/or other like information. Other categorical features are possible and will depend on the particular use case. In some implementations of the present invention, the categorical features can be one-hot encoded to calculate, convert, or otherwise map the categorical features to numerical representations for the feature vector x. The feature vector x can be passed to the model development module 116 to generate the expected value p based on an a posteriori weight distribution, as discussed previously. The user response prediction module 118 can receive the expected value p from the model development module 116. The user response prediction module 116 can also use a target value y (e.g., click, install, engagement, purchase, number of purchases, revenue, or the like), which can be predetermined or calculated by the user response prediction module 118. In some implementations of the present invention, the target value y can be the target cost per engagement (CPE), although other target values or metrics are possible. The CPE price can be the price that is paid when a content presentation (e.g., a digital ad) is engaged with by a user on their client device. Accordingly, the content presentation impression value v can be calculated by the user response prediction module 118 according to Equation (8):

v=p×y (8)

An impression is a view, display, presentation, or other surfacing of a content presentation to a user on their client device. The content presentation impression value v can be the value of the content presentation impression. In some implementations of the present invention, the content presentation impression value v can be used to determine an appropriate response to the request (e.g., a bid value in the form of a bid price in response to a request as part of, for example, an auction process or the like).

In an embodiment, the content presentation impression value v calculated by the user response prediction module 118 and the feature vector x can be passed to the response determination module 120. The response determination module 120 can be used to determine an amount or value to respond or otherwise bid (e.g., bid price b) to maximize an expected profit E[v−b]. In an embodiment, the response determination module 120 can model the win probability w as a function according to Equation (9):

$$w = \frac{b}{( c ( x ) + b )} \qquad ( 9 )$$

Consequently, the response determination module 120 can calculate the response value or bid price b according to Equation (10):

b=arg max_{b}w(v−b) (10)

Other ways of calculating the response value or bid price b are possible. The response determination module 120 can generate a response to the original request (e.g., a bid response to the request in an auction process or the like) that can include the response value or bid price b and, optionally, a suitable content presentation (e.g., retrieved or otherwise generated from the user response data database 122) and transmit or otherwise send the response to the content presentation exchange 126 (e.g., via network 110). In an embodiment, the content presentation can be selected from a plurality or set of content presentations. In some implementations of the present invention, the response determination module 120 can select a content presentation (e.g., an optimal content presentation) based on the feature vector x using a suitable model or technique (e.g., Multi-armed Beta/Bernoulli bandit, a Multivariate bandit, or the like). In an embodiment, a Contextual bandit can be used to determine a content presentation (e.g., an optimal content presentation). For example, a Bayesian Logistic Regression (LR) model or other like model can be built (e.g., using the model development module 116). The Bayesian LR model can identify suitable a posteriori weight distributions wᵢ according to Equation (11):

arg maxᵢyᵢ=σ(w·x);wᵢ˜N(m,q) (11)

For example, the Bayesian LR model can use Thompson sampling, which is an explore/exploit technique that operates on the a posterior weight distributions during prediction. Other techniques for identifying suitable a posteriori weight distributions are possible. Thus, the response determination module 120 can automatically adjust and generate, determine, or optimize responses to requests (e.g., bids in response to requests in an auction process or the like) in real-time based on the user response prediction (and the subsequently calculated content presentation impression value v) and the feature vector x.

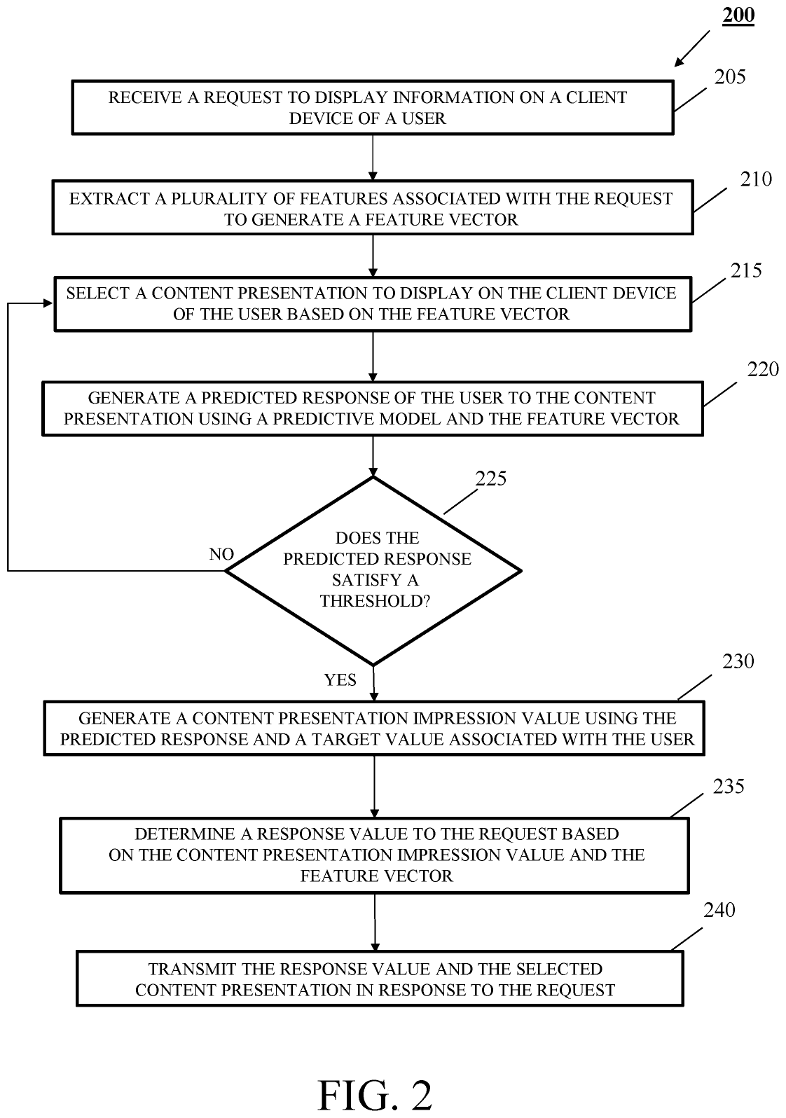

FIG. 2 is a block diagram illustrating an example method 200 for real-time user response prediction for content presentations on client devices. In some implementations of the present invention, the method 200 can be performed as part of an auction or other like process that is managed by the content presentation exchange 126. At block 205, the user response prediction module 118 can receive a request (e.g., a bid request or the like for an auction or auction-like process from the content presentation exchange 126 via the network 110) to display information on a client device of a user. At block 210, the user response prediction module 118 can extract a plurality of features associated with the request to generate a feature vector. For purposes of illustration and not limitation, the feature vector can include categorical features such as, for example, publisher (e.g., app, category, etc.), placement, user (e.g., age, gender, device identifier, etc.), time of day, day of week, week of year, geographical location (e.g., country, region, DMA, etc.), and/or other like information, although other features are possible. In some implementations of the present invention, the categorical features can be one-hot encoded to calculate, convert, or otherwise map the categorical features to numerical representations for the feature vector. At block 215, the user response prediction module 118 can select a content presentation to display on the client device of the user based on the feature vector. For example, the user response prediction module 118 can retrieve content presentations from the user response data database 122. At block 220, the model development module 116 can generate a predicted response of the user to the content presentation using a predictive model and the feature vector. In some implementations of the present invention, the predictive model can be a Bayesian Logistic Regression model or the like. At block 225, the user response prediction module 118 can determine if the predicted response satisfies (e.g., is greater than or equal to) a suitable (predetermined or tunable) threshold. If the predicted response does not satisfy (e.g., is below) the (predetermined or tunable) threshold, then the user response prediction module 118 can return to block 215 to select an alternative content presentation. In some implementations of the present invention, the method 200 can end at block 225 (i.e., not return to block 215 and not proceed to block 230) if the predicted response does not satisfy (e.g., is below) the threshold. If the predicted response satisfies (e.g., is at or above) the threshold, then at block 230 the user response prediction module 118 can generate a content presentation impression value using the predicted response and a target value associated with the user. At block 235, the response determination module 120 can determine a response value to the request based on the content presentation impression value and the feature vector. At block 240, the response determination module 120 can transmit the response value and the selected content presentation (e.g., to the content presentation exchange 126 via the network 110) in response to the request. The content presentation can be displayed on the client device of the user when the response is accepted (e.g., accepted by the content presentation exchange 126 as part of an auction or auction-like process).

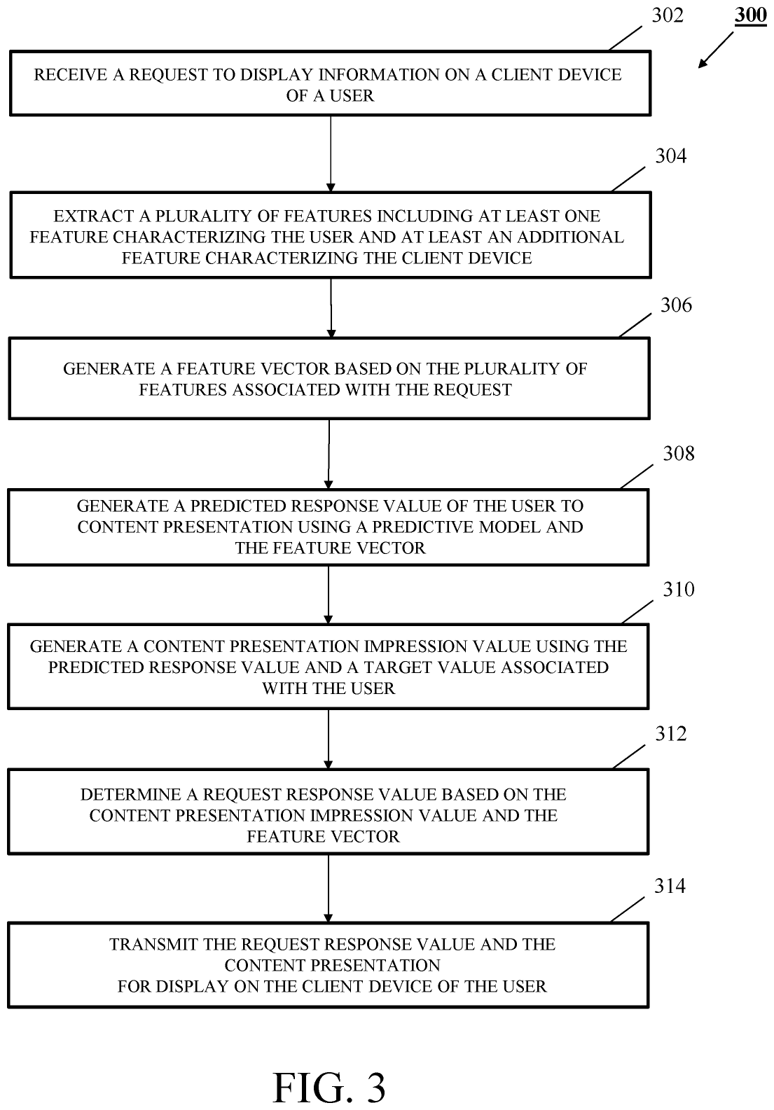

FIG. 3 is a block diagram illustrating another example method 300 for predicting a user response to content presentations on a client device. In embodiments, at block 302, the user response prediction module 118 can receive a request (e.g., a bid request or the like from the content presentation exchange 126 via the network 110 as part of an auction or auction-like process) to display information on a client device of a user. As stated above, the information that is output or displayed on a client device of the user may include digital advertisements, creative assets, and so forth, which may include text, images, video, audio, and/or the like. Further, such information may be presented outside of or within a software application executing on the client device of the user. In embodiments, at block 304, the user response prediction module 118 may extract a plurality of features associated with the request. These features may include at least one feature characterizing the user and at least one additional feature characterizing the client device. As stated above, the plurality of features may include information, such as, for example, data characterizing a publisher, a location of placement of the content presentation on a screen of the client device, data associated with the user such as, e.g., age, gender, and so forth. Further, the plurality of features may also include a geographic location specific to the user and/or the client device. The at least one feature characterizing the user may correspond to information such as age, gender, and so forth, and the at least one feature characterizing the client device may include a device identifier or other comparable information that characterizes the client device.

In embodiments, at block 306, the user response prediction module 118 may generate a feature vector. The feature vector may correspond to a list of a particular size and may include, for instance, 5, 10, or 15 features, although any suitable number of features are possible. As discussed above, the feature vector can be a numerical representation of a combination of user attributes and/or other attributes. For example, a feature vector can include of a plurality of numbers and be of any appropriate length depending on the desired number of features captured in the feature vector. In some implementations of the present invention, one-hot encoding can be used for all or part of the feature vector to calculate the numerical representations of each or any features in a set of features. In embodiments, one or more of the plurality of features described above with respect to block 304 may be stored as part of the feature vector that is generated at block 306.

In embodiments, at block 308, the model development module 116 may generate a predicted response value of the user, in particular, to a content presentation, namely a content presentation that may be displayed on a client device of the user. The predicted response value may be determined using a predictive model and the feature vector generated at block 306. In embodiments, the predictive model may be a Bayesian Logistic Regression Model or the like. In embodiments, the predictive model may be built by the model development module 116 and trained using, for example, mini-batch Limited-memory Broyden-Fletcher-Goldfarb-Shanno (L-BFGS) or the like. Alternatively, in embodiments, the predictive model may include Ridge, Lasso, Elastic Net, Adaptive Lasso, Group Lasso, Randomized Lasso, and/or other appropriate regression models. Additionally or alternatively, the predictive model can be or include a classifier such as, for example, one or more linear classifiers (e.g., Fisher's linear discriminant, logistic regression, Naive Bayes classifier, and/or perceptron), support vector machines (e.g., least squares support vector machines), quadratic classifiers, kernel estimation models (e.g., k-nearest neighbor), boosting (meta-algorithm) models, decision trees (e.g., random forests, Gradient Boosting Trees), neural networks, and/or learning vector quantization models, and so forth.

In embodiments, at block 310, a content presentation impression value may be generated using the predicted response value and a target value associated with the user. It is noted that the predicted response value can characterize a likelihood of the user interacting with the content presentation and the target value can characterize a cost of an interaction of the user with the content presentation. Further, it is noted that the content presentation impression value may be generated when the predicted response value satisfies a predetermined or tunable threshold. For example, the predicted response value may be represented in the form of a probability value ranging from 0 to 1. It is noted that other threshold values and value ranges may also be utilized. Further, the target value can represent a cost of an interaction of the user with the content presentation that is displayed on the client device of the user. As stated above, the target value may correspond to a price associated with a particular instance of engagement between the user and a content presentation. It is noted that other metrics may also be utilized.

In embodiments, at block 312, the response determination module 120 may determine a response value (i.e., a request response value) based on the content presentation impression value and the feature vector. It is noted that the response value (i.e., the request response value) can correspond to a bid value or a bid price for the opportunity to display the content presentation on the client device of the user. As discussed above, such a request response value may be calculated using Equation (10), which is repeated below:

b=arg max_{b}w(v−b) (10)

Finally, at block 314, the response determination module 120 may operate to transmit the request response value and the content presentation for display on the client device of the user. For example, the content presentation can be displayed on the client device of the user when the request response value is accepted (e.g., accepted by the content presentation exchange 126 as part of an auction or auction-like process). In embodiments, the transmission may be implemented wirelessly or via a wired connection.

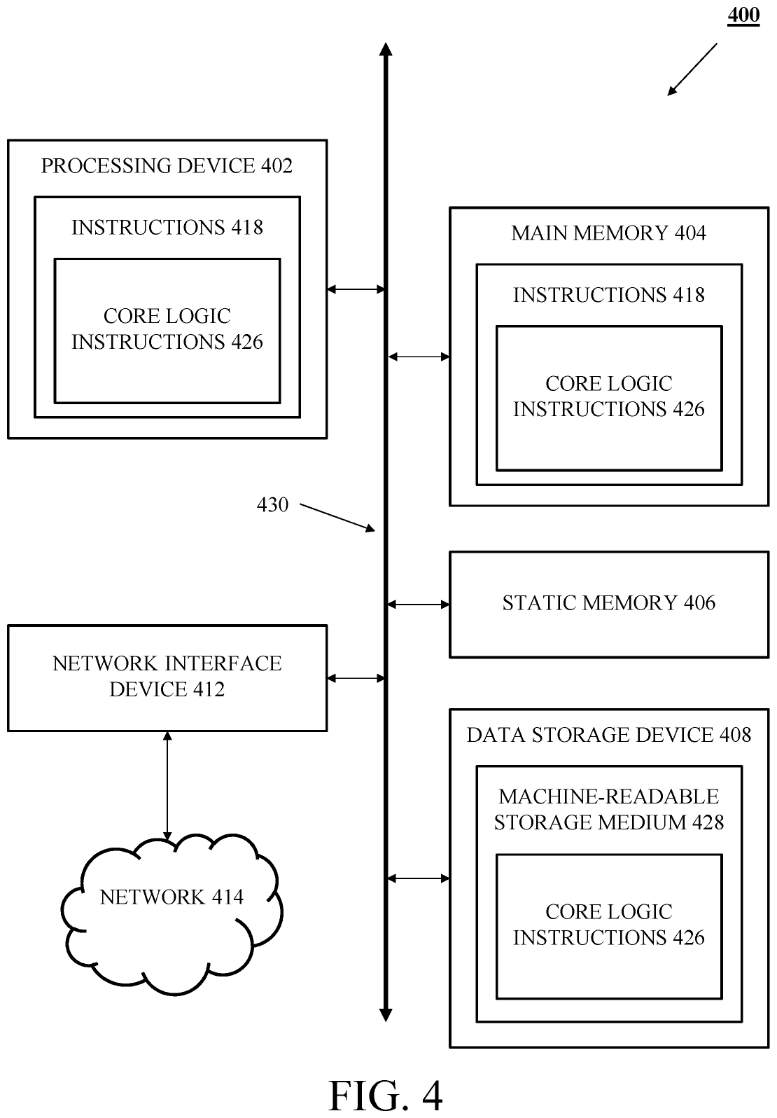

FIG. 4 is a block diagram of an example computing device 400 that may perform one or more of the operations described herein, in accordance with the present embodiments. The computing device 400 may be connected to other computing devices in a LAN, an intranet, an extranet, and/or the Internet. The computing device 400 may operate in the capacity of a server machine in client-server network environment or in the capacity of a client in a peer-to-peer network environment. The computing device 400 may be provided by a personal computer (PC), a set-top box (STB), a server, a network router, switch or bridge, or any machine capable of executing a set of instructions (sequential or otherwise) that specify actions to be taken by that machine. Further, while only a single computing device 400 is illustrated, the term “computing device” shall also be taken to include any collection of computing devices that individually or jointly execute a set (or multiple sets) of instructions to perform the methods discussed herein.

The example computing device 400 may include a computer processing device 402 (e.g., a general purpose processor, ASIC, etc.), a main memory 404, a static memory 406 (e.g., flash memory or the like), and a data storage device 408, which may communicate with each other via a bus 430. The computer processing device 402 may be provided by one or more general-purpose processing devices such as a microprocessor, central processing unit, or the like. In an illustrative example, computer processing device 402 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. The computer processing device 402 may also comprise one or more special-purpose processing devices, such as an application specific integrated circuit (ASIC), a field programmable gate array (FPGA), a digital signal processor (DSP), network processor, or the like. The computer processing device 402 may be configured to execute the operations described herein, in accordance with one or more aspects of the present disclosure, for performing the operations and steps discussed herein.

The computing device 400 may further include a network interface device 412, which may communicate with a network 414. The data storage device 408 may include a machine-readable storage medium 428 on which may be stored one or more sets of instructions, e.g., instructions for carrying out the operations described herein, in accordance with one or more aspects of the present disclosure. Instructions 418 implementing core logic instructions 426 may also reside, completely or at least partially, within main memory 404 and/or within computer processing device 402 during execution thereof by the computing device 400, main memory 404 and computer processing device 402 also constituting computer-readable media. The instructions may further be transmitted or received over the network 414 via the network interface device 412.

While machine-readable storage medium 428 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media, magnetic media, and the like.

Embodiments of the subject matter and the operations described in this disclosure can be implemented in digital electronic circuitry, or in computer software, firmware, or hardware, including the structures disclosed in this disclosure and their structural equivalents, or in combinations of one or more of them. Embodiments of the subject matter described in this disclosure can be implemented as one or more computer programs, i.e., one or more modules of computer program instructions, encoded on computer storage medium for execution by, or to control the operation of, data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this disclosure can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer processing device, a computer, a system on a chip, or multiple ones, or combinations, of the foregoing. A computer processing device may include one or more processors which can include special purpose logic circuitry, e.g., an FPGA (field programmable gate array) or an ASIC (application specific integrated circuit), a central processing unit (CPU), a multi-core processor, etc. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative, procedural, or functional languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto optical disks, optical disks, solid state drives, or the like. However, a computer need not have such devices. Moreover, a computer can be embedded in another device, e.g., a smart phone, a mobile audio or media player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), LCD (liquid crystal display) monitor, a light emitting diode (LED) monitor, or the like, for displaying information to the user and a keyboard and a pointing device, e.g., a mouse, a trackball, a touchpad, a stylus, or the like, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like. In addition, a computer can interact with a user by sending resources to and receiving resources from a device that is used by the user; for example, by sending web pages to a web browser on a user's client device in response to requests received from the web browser.

Embodiments of the subject matter described in this disclosure can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), peer-to-peer networks (e.g., ad hoc peer-to-peer networks), and the like.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML, page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Reference throughout this disclosure to “one embodiment” or “an embodiment” means that a particular feature, structure, or characteristic described in connection with the embodiments included in at least one embodiment. Thus, the appearances of the phrase “in one embodiment” or “in an embodiment” in various places throughout this disclosure are not necessarily all referring to the same embodiment. In addition, the term “or” is intended to mean an inclusive “or” rather than an exclusive “or.”

While this disclosure contains many specific implementation details, these should not be construed as limitations on the scope of any inventions or of what may be claimed, but rather as descriptions of features specific to particular embodiments of particular inventions. Certain features that are described in this disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations and/or logic flows are depicted in the drawings and/or described herein in a particular order, this should not be understood as requiring that such operations and/or logic flows be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The above description of illustrated implementations of the invention is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. Other implementations may be within the scope of the following claims.

What is claimed is:

1. A method, comprising:
receiving a request to display information on a client device of a user;
extracting a plurality of features associated with the request, the plurality of features including at least one feature characterizing the user and at least an additional feature characterizing the client device;
generating a feature vector based on the plurality of features associated with the request;
generating a predicted response value of the user to a content presentation using a predictive model and the feature vector, the predicted response value characterizing a likelihood of the user interacting with the content presentation;
generating, when the predicted response value satisfies a predetermined threshold, a content presentation impression value using the predicted response value and a target value associated with the user, the target value characterizing a cost of an interaction of the user with the content presentation;
determining a request response value based on the content presentation impression value and the feature vector; and
transmitting the request response value and the content presentation for display on the client device of the user.

2. The method of claim 1, wherein the predictive model is a Bayesian Logistic Regression model.

3. The method of claim 1, wherein the predicted response value further characterizes a likelihood of a downstream conversion of the user in response to interacting with the content presentation.

4. The method of claim 1, wherein the generating of the content presentation impression value using the predicted response value and the target value associated with the user includes multiplying the target value and the predicted response value.

5. The method of claim 1, further comprising:
selecting the content presentation for display on the client device of the user based on the feature vector.

6. The method of claim 1, further comprising:
selecting an alternative content presentation for display on the client device responsive to determining that the predicted response value of the user to the content presentation does not satisfy the predetermined threshold.

7. The method of claim 6, further comprising:
generating an additional predicted response value of the user to the alternative content presentation using the predictive model and the feature vector.

8. The method of claim 7, further comprising:
generating, when the additional predicted response value satisfies the predetermined threshold, an additional content presentation impression value using the additional predicted response value and the target value associated with the user.

9. The method of claim 1, further comprising:
implementing a filter model in association with the predictive model.

10. The method of claim 9, wherein the implementing of the filter model includes determining an additional likelihood that the user converts in a particular category associated with one or more additional content presentations.

11. A system, comprising:
at least one data processor; and
memory storing instructions, which, when executed by the at least one data processor, cause the at least one data processor to perform operations comprising:
receiving a request to display information on a client device of a user;
extracting a plurality of features associated with the request, the plurality of features including at least one feature characterizing the user and at least an additional feature characterizing the client device;
generating a feature vector based on the plurality of features associated with the request;
generating a predicted response value of the user to a content presentation using a predictive model and the feature vector, the predicted response value characterizing a likelihood of the user interacting with the content presentation;
generating, when the predicted response value satisfies a predetermined threshold, a content presentation impression value using the predicted response value and a target value associated with the user, the target value characterizing a cost of an interaction of the user with the content presentation;
determining a request response value based on the content presentation impression value and the feature vector; and
transmitting the request response value and the content presentation for display on the client device of the user.

12. The system of claim 11, wherein the predictive model is a Bayesian Logistic Regression model.

13. The system of claim 11, wherein the predicted response value further characterizes a likelihood of a downstream conversion of the user in response to interacting with the content presentation.

14. The system of claim 11, wherein the at least one data processor performs the operation of the generating the content presentation impression value using the predicted response value and the target value associated with the user by multiplying the target value and the predicted response value.

15. The system of claim 11, wherein the operations further comprise:
selecting the content presentation for display on the client device of the user based on the feature vector.

16. The system of claim 11, wherein the operations further comprise:
selecting an alternative content presentation for display on the client device responsive to determining that the predicted response value of the user to the content presentation does not satisfy the predetermined threshold.

17. The system of claim 16, wherein the operations further comprise:
generating an additional predicted response value of the user to the alternative content presentation using the predictive model and the feature vector.

18. The system of claim 11, wherein the operations further comprise:
implementing a filter model in association with the predictive model.

19. The system of claim 18, wherein the operation of implementing the filter model includes determining an additional likelihood that the user converts in a particular category associated with one or more additional content presentations.

20. A non-transitory computer program product storing executable instructions, which, when executed by at least one data processor forming part of at least one computing system, implement operations comprising:
receiving a request to display information on a client device of a user;
extracting a plurality of features associated with the request, the plurality of features including at least one feature characterizing the user and at least an additional feature characterizing the client device;
generating a feature vector based on the plurality of features associated with the request;
generating a predicted response value of the user to a content presentation using a predictive model and the feature vector, the predicted response value characterizing a likelihood of the user interacting with the content presentation;
generating, when the predicted response value satisfies a predetermined threshold, a content presentation impression value using the predicted response value and a target value associated with the user, the target value characterizing a cost of an interaction of the user with the content presentation;
determining a request response value based on the content presentation impression value and the feature vector; and
transmitting the request response value and the content presentation for display on the client device of the user.
